(19) United States
(12) Patent Application Publication
(10) Pub. No.: US 2013/0263984 A1
(43) Pub. Date: Oct. 10, 2013

(54) NOISE ATTENUATOR DEVICES FOR TIRES

(71) Applicants: Patrick Bervas, Clermont-Ferrand-Cedex 9 (FR); Jean-Claude Faure, Clermont-Ferrand-Cedex 9 (FR)

(72) Inventors: Patrick Bervas, Clermont-Ferrand-Cedex 9 (FR); Jean-Claude Faure, Clermont-Ferrand-Cedex 9 (FR)

(73) Assignees: Michelin Recherche et Technique S.A., Granges-Paccot (CH); COMPAGNIE GENERALE DES ETABLISSEMENTS MICHELIN, Clermont-Ferrand (FR)

(21) Appl. No.: 13/878,573

(22) PCT Filed: Oct. 13, 2011
(86) PCT No.: PCT/EP11/67939

§ 371 Date: Jun. 24, 2013

(30) Foreign Application Priority Data
Oct. 14, 2010 (FR) 1058392

(51) Int. Cl. B60C 11/03

(52) U.S. Cl. CPC B60C 11/0327
USPC 152/154.2; 152/209.18

(57) ABSTRACT

A tire comprising a tread having a running surface, and at least one groove of generally circumferential orientation and a plurality of relief elements, each of which has a contact face with a transverse width Lt and lateral walls, at least one being provided with a plurality of devices for attenuating resonance noise, being formed in a relief element and comprising a cavity of elongate shape having a total length Lc and a total volume Vc, opening onto a lateral wall, having a total length Lc which is greater than the transverse width Lt, and a geometry comprising several cavity portions connected together, wherein the length Lc equal to the sum of the lengths of all the cavity portions, being extended over the whole of its length Lc by a sipe extending radially outwards opening onto the running surface, this tread being such that the sum Ly of the lengths projected in the transverse direction of each cavity is at least 1.5 times greater than the sum Lx of the lengths projected in the circumferential direction of each cavity.

### FIELD OF THE INVENTION

The present invention relates to tire treads and more particularly devices incorporated into these treads for reducing noise when running.

### DESCRIPTION OF THE PRIOR ART

Usually, the tires for passenger vehicles are provided with a carcass reinforcement which, these days, is radial in the great majority; in this configuration, the reinforcers of the carcass reinforcement are placed so as to make an angle of 80 degrees or more with the circumferential direction (which amounts to saying that the reinforcers are contained in a radial plane (the plane containing the rotation axis) or make an inclination of at most 20 degrees with this plane).

Usually, these tires are provided with a crown reinforcement comprising a plurality of reinforcers immersed in an elastomer-based material. This crown reinforcement is covered radially on the outside by a tread made of rubber material, this tread having a surface, called the running surface, designed to be in contact with the road when running.

In order to ensure an indispensable level of safety during rainy weather in particular, it is usual to provide the tread with a plurality of grooves of generally circumferential (or longitudinal) orientation and grooves of generally transverse orientation (parallel to or making a slight angle with the rotation axis).

One drawback of the presence of longitudinal grooves is the generation of vibrations of the air flowing in these grooves notably when in contact with the road. These vibrations are the cause of resonances generating a running noise.

The publication of patent application JP-01-191734 relates to this mechanism and proposes to reduce the noise generated by the air vibrating inside these grooves by forming, in the thickness of the tread of a tire for a heavy goods vehicle, spherical cavities emerging via a channel of reduced section in a longitudinal groove. In this way, it is possible to produce a sort of resonator operating on the principle of a Helmholtz resonator. Specifically, such a cavity, through its precisely determined volume, plays this role and makes it possible to reduce the effect of certain frequencies of vibration of the air flowing in the grooves when coming into contact with the roadway. The volume of these cavities must be appropriate for each chosen frequency. The application to tires for heavy goods vehicles is possible because, as a general rule, the thickness of the elements of the tread is considerable compared with that of the treads of tires for passenger vehicles.

For a passenger vehicle, since the thickness of tread is relatively small (that is to say less than 10 mm), it becomes essential to place these resonators as far as possible from the running surface of the tread and more particularly at a depth greater than the depth of the grooves, or at least at the depth of said grooves minus the legally-required quantity (indicated by the wear indicators which are blocks of rubber provided at the bottom of the grooves and of which the radially outer surface indicates the limit of tread wear that must not be exceeded in order to maintain a satisfactory safety level). Although, in the case of tires intended to be fitted to a heavy goods vehicle as described in JP-01-191734, it seems possible to mold and to remove from the mold a tire with the mold elements molding the hemispheric cavities, these cavities opening into grooves, it becomes difficult with tires for passenger vehicles if only through the considerable length of these cavities (the length necessary to obtain an appropriate volume).

Another drawback of the tread described in document JP-01-191734 lies in the fact that the spherical cavity of relatively large volume may affect the way in which the rubber element that contains it will squash against the ground when running and notably the distribution of the contact pressures. Moreover, the cavities of JP-01-191734 are not sufficiently long-lasting since, after partial wear of the tread, these cavities open onto the running surface: the volume is no longer retained and the operation as a resonator is thereby disrupted.

In a patent application published under number WO 2009/095288, the applicants proposed a new tread comprising cavities forming resonators in order to attenuate groove resonance noise when coming into contact with a roadway. These cavities are formed to be both virtually insensitive to tread wear and to be easily molded and removed from the mold, while providing excellent control of the volume of each cavity in order to be able to fully play the role of resonator for a fixed frequency of resonance. “Virtually insensitive” means that the volume of the cavities is unchanged until the tread wear reaches ⅔ of the thickness of said tread. After this amount of wear, the cavities open onto the running surface to form groove portions that serve as a reservoir for the water that is on the roadway. The resonators in question may be of the Helmholtz type or of the quarter-wave type as they are generally known.

Placing resonators of the Helmholtz type or of the quarter-wave type in tire treads for passenger vehicles requires an appropriate cavity volume that is sometimes incompatible with the thickness of this tread and the width dimensions of the ribs or relief elements of the tread. This cavity volume may cause a significant reduction in the transverse rigidity of the tread notably when this tread is subjected to tangential forces directed transversely, that is to say in a direction parallel to the rotation axis of the tire provided with said tread.

Definitions:

Equatorial mid-plane: this is the plane that is perpendicular to the rotation axis and passes through the points of the tire that are radially furthest from said axis. This plane divides the tire into two equal or substantially equal portions.

A block is a relief element formed on the tread that is delimited by cavities or grooves and comprises lateral walls and a contact face designed to come into contact with the roadway.

A rib is a relief element delimited by two grooves of the same orientation; this rib comprises two lateral faces and a contact face intersecting the lateral faces to form ridges.

“Radial direction”, in the present document, means a direction that is perpendicular to the rotation axis of the tire (this direction corresponds to the direction of thickness of the tread).

“Axial direction” means a direction parallel to the rotation axis of the tire.

“Circumferential or longitudinal direction” means a direction that is perpendicular both to the axial direction and a radial direction. This circumferential direction is tangential to any circle centered on the rotation axis of the tire.

### BRIEF DESCRIPTION OF THE INVENTION

The object of the present invention is to solve the problem posed and allow the installation of resonators that have an appropriate cavity volume while limiting the induced effects of reducing the rigidity of the thread when this tread is stressed transversely.

Accordingly, the subject of the invention is a tire comprising a tread having a running surface designed to come into contact with a roadway when the tire is running, this tread comprising at least one groove of generally circumferential orientation (not necessarily straight—it may zigzag) and a plurality of relief elements (rib or block), each of these relief elements comprising lateral walls and a contact face with a transverse width Lt (the distance measured between the lateral walls of the element), this contact face forming a portion of the running surface, certain of these lateral walls partly delimiting the grooves of generally circumferential orientation,

at least one relief element being provided with a plurality of devices for attenuating resonance noise generated in a circumferential groove adjacent to said relief element,

each attenuating device being formed in a relief element and essentially comprising a cavity of elongate shape having a total length Lc and a total volume Vc,

this cavity being entirely formed in the tread so as to be effective as an attenuating device,

this cavity opening onto a lateral wall delimiting the circumferential groove the resonance noise of which it is sought to reduce,

this cavity having, seen in projection on the running surface of the tread in the new state, a total length Lc which is greater than the transverse width Lt of the relief element, and a geometry comprising several cavity portions connected together, the length Lc being equal to the sum of the lengths of all the cavity portions,

said cavity portions having a total length projected in the circumferential direction equal to Lx and a total length projected in the transverse direction equal to Ly, these projected total lengths Lx, Ly being equal respectively to the sum of the lengths of the projections in the circumferential direction or in the transverse direction of each cavity portion,

each cavity being extended over the whole of its length Lc by a sipe extending radially outwards in order to open onto the running surface.

This tread is characterized in that the total length Ly projected in the transverse direction is at least 1.5 times greater than the total length Lx projected in the circumferential direction.

Preferably, the total length Lc of the cavity is at least equal to twice the width Lt of the relief element and even more preferably at least equal to three times the width; it is possible to envisage cavity lengths that are much more than twice the width Lt of the relief element. Thus, for a total cavity volume Vc, this volume being determined as a function of the chosen frequency of which the resonance noise is sought to be reduced, it is possible to reduce the average section Sc of each cavity. The invention makes it possible to distribute this total cavity volume so as to induce less disruption in the rigidities of the relief element by lengthening said cavity sufficiently and distributing a larger portion of the cavity length in the transverse direction.

The resonators according to the invention, while substantially reducing the resonance noise of the grooves of a tread, make it possible to obtain a satisfactory balance between the longitudinal rigidity and the transverse rigidity of this tread subjected to the stresses of the roadway when running.

Advantageously, each cavity is entirely formed in the tread so as to be effective as an attenuating device at least for ⅔ of the period of usage of the tread (that is to say that this cavity does not appear on the running surface before this ⅔ wear of the thickness beginning from the new state).

The cavities according to the invention may be of the Helmholtz resonator type or of the quarter-wave resonator type. In the particular case of a Helmholtz resonator, each cavity comprises a main portion with an average section Sc and a portion of reduced section Sr (less than the section Sc) and of length Lr: the volume of this portion of reduced section represents a very small fraction of the total volume Vc. This portion of reduced section opens into the groove the resonance noise of which it is sought to reduce, the total volume Vc of the cavity including the volume of this portion of reduced section and the length Lc also including the length of this portion of reduced section.

For cavities of the quarter-wave type, the section Sc is constant over the whole length Lc of the cavity.

According to one embodiment of the invention, the sipe extending the cavity towards the running surface has an average width of less than 0.6 mm.

According to another embodiment of the invention that is particularly advantageous in ensuring the effectiveness of the resonators, the sipe comprises a sipe portion originating on the cavity and forming an angle A of at least 10 degrees with a perpendicular to the running surface and passing through the point of intersection of the sipe with the cavity, so that the sipe is closed at least close to the cavity in order to prevent any variation in the total volume Vc of said cavity when said cavity comes into contact with the roadway.

In order to satisfy the conditions of the invention, it is advantageous to ensure that each cavity has a shape comprising at least two portions of generally transverse orientation and at least one portion connecting these portions of generally transverse orientation together. The greater the number of portions of transverse orientation, the greater the total length in projection in this transverse direction with respect to the projection in the circumferential direction and the more the impact of the presence of these cavities on the reduction in rigidity is reduced.

Yet more preferably, cavity shapes are used that comprise at least three portions of transverse orientation. The distance between the portions of transverse orientation is determined so as not to have too marked an impact on the rigidity of the tread in compression.

In order to obtain a long-lasting noise effect in use, it is advantageous that, since the tread is provided with wear indicators in the bottom of at least one groove, this wear indicator having a height h measured relative to the bottom of the groove, each cavity forming a resonator comprises an upper generatrix situated at a distance from the running surface that is at least equal to the depth of the grooves minus the height h of the wear indicator. Thus, each cavity retains its role as a resonator until the wear of the tread reaches a maximum level as authorized by the road regulations.

Other features and advantages of the invention will emerge from the description made below with reference to the appended drawings which show, as non-limiting examples, embodiments of the subject of the invention.

### BRIEF DESCRIPTION OF THE FIGURES

FIG. 1 shows a tread according to the prior art;

FIG. 2 shows a section along a sectional plane II-II of the tread according to FIG. 1;

FIG. 3 shows partially a tread according to the invention comprising a first resonator variant having the shape of the letter H;

FIG. 4 shows a view in perspective of a portion of the tread shown with FIG. 3;

FIG. 5 shows a section along a line V-V taken from the tread shown with FIG. 3 when not in contact with a roadway;

FIG. 6 shows the same section as in FIG. 5 when coming into contact with a roadway;

FIG. 7 represents two other variants of cavities forming a resonator;

FIG. 8 shows another variant of a cavity having the general shape of the letter Z and forming a quarter-wave resonator.

### DESCRIPTION OF THE FIGURES

In order to make it easier to read the figures, the same reference marks are used for the description of variants of the invention when these reference marks refer to elements of one and the same kind whether structural or functional.

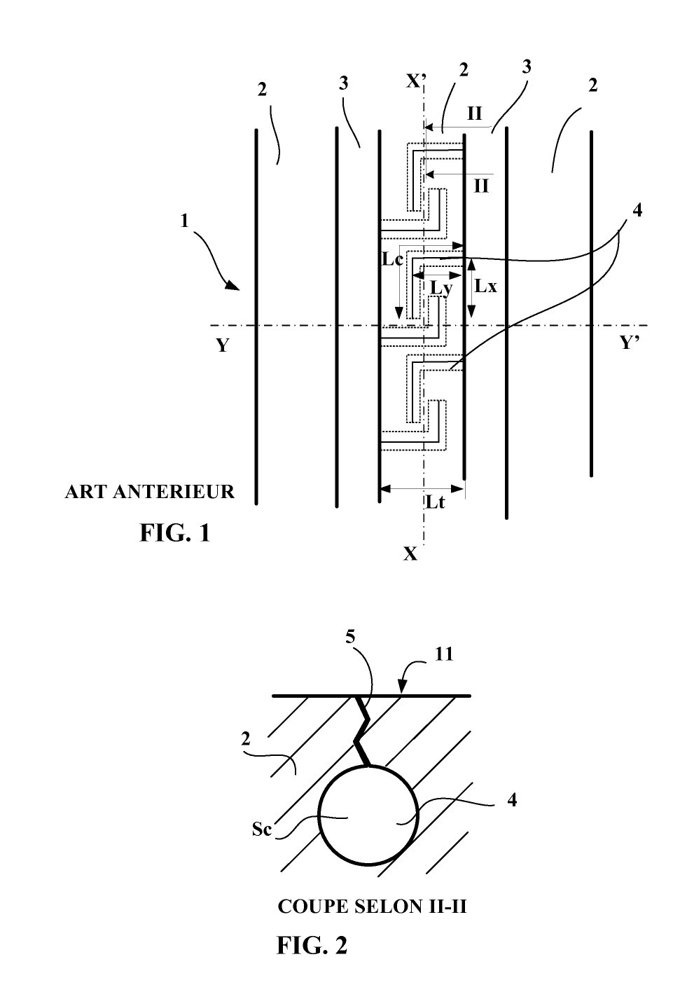

FIG. 1 shows a portion of a tread 1 according to the prior art as described in the application published under number WO 2009/095288. This FIG. 1 shows three ribs 2 of circumferential orientation delimiting two grooves 3. Each rib has a width Lt. In order to lower the noise level generated by the resonance of the air in the two grooves 3, a plurality of cavities 4 having the shape of the letter “L” are formed in the central rib, each of the two branches of this cavity having substantially equal lengths. Thus, the sum Ly of the projections of the total length Lc of this cavity in the circumferential direction (marked by the direction YY″ in FIG. 1) is substantially equal to the sum Lx of the projections of the total length Lc of this same cavity in the transverse direction (marked by the direction XX′ in FIG. 1). In fact, all the components in the direction XX′ and all the components in the direction YY′ are added together to obtain respectively Lx and Ly.

FIG. 2 shows a section along a sectional plane of which the trace in FIG. 1 is marked by the line II-II. This FIG. 2 shows the rib 2 in the direction of its thickness. The cavity 4 forming a resonator has a section Sc that is substantially circular and is extended radially towards the contact surface 11 of the rib 2 by a sipe 5 of zigzag shape capable of being closed when coming into contact with the roadway in order to allow the total volume Vc of the cavity 4 to be controlled.

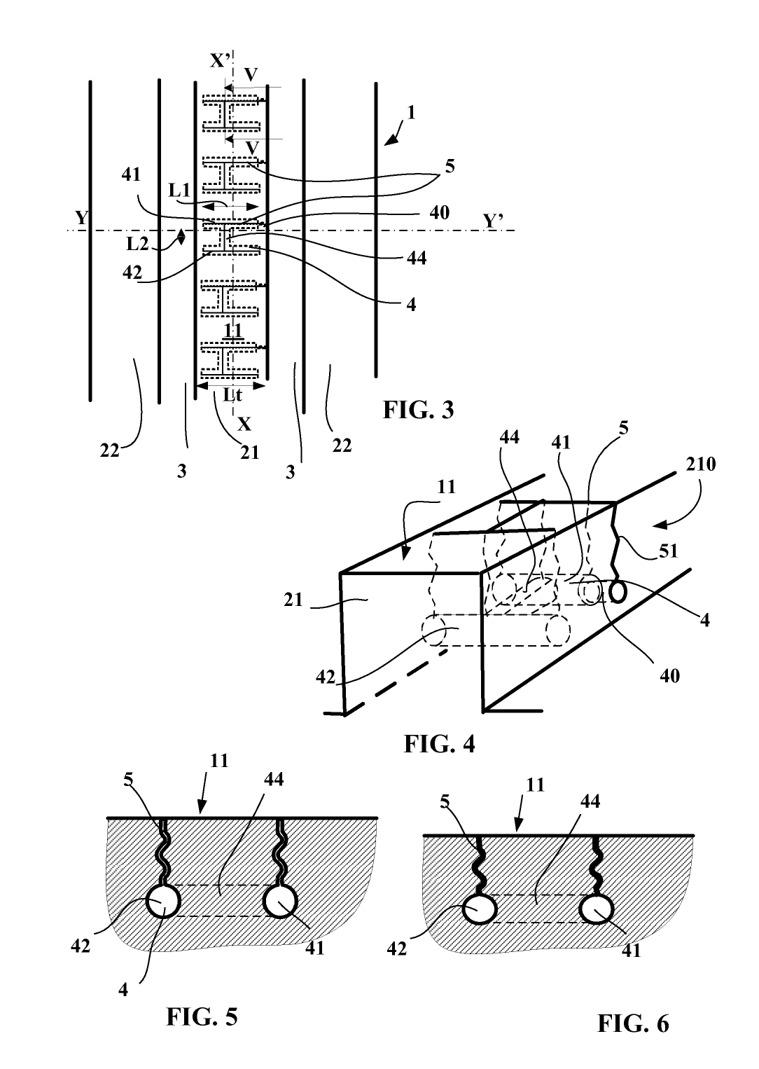

FIG. 3 represents a first variant of a tread 1 of a tire of dimension 225/55 R 16, this tread being provided with a plurality of devices 4 for attenuating resonance noise according to the invention.

According to this variant, the tread comprises two circumferential grooves 3 delimiting a central rib 21 and two side ribs 22.

The central rib 21 with a width Lt equal to 35 mm is provided with a plurality of cavities 4 of total length Lc, each cavity having a general shape similar to that of the letter “H”, the total length Lc being equal to the sum of the lengths of all the branches of this shape. The average section of the cavity is of circular shape with a diameter equal to 3 mm. Each cavity 4 forms a Helmholtz resonator of total volume Vc, this volume comprising a portion 40 of length Lr having a volume Vr that is small compared with the total volume Vc of the cavity and of reduced section relative to the section Sc of the cavity. This cavity portion 40 opens onto a lateral wall 210 of the central rib as can be seen in FIG. 4 to produce a Helmholtz resonator.

Each cavity 4 comprises several cavity portions connected together: a first cavity portion 41 of linear shape is formed in the extension of the portion 40 of reduced section and has a length L1 equal to 24 mm. Parallel to this cavity portion of length L1 another cavity portion 42 is formed substantially of the same length L1. These two cavity portions 41, 42 are oriented parallel to the transverse direction YY′ (hence perpendicularly to the circumferential direction marked by the direction XX′).

Furthermore, a cavity portion 44 of length L2, in this instance equal to 28 mm, is provided to ensure the continuity between the volumes of the cavity portions 41, 42 of length L1. This cavity portion 44 of length L2 has a circular section with the same diameter as the section of the cavity portions 41, 42 of length L1.

The total length Lc of the cavity (this length Lc being equal to the sum of the lengths, whether these lengths are transverse or circumferential, of all the cavity portions 40, 41, 42, 44) is clearly much greater than the width Lt of the rib 21 measured in the transverse direction (the length Lc is in this instance equal to 76 mm and Lt is equal to 33 mm).

Furthermore, the cavity 4 is extended radially outwards and over the whole of its length Lc by a sipe 5 extending between the points limiting said cavity and situated radially outside the cavity up to the contact face 11 of the rib 21. This sipe 5 is used notably for the molding and removal from the mold of the cavity 4 inside the tread. Naturally, it is advantageous that this sipe 5 is adapted to close close to the cavity 4 in order to allow control of the volume Vc of said cavity when coming into contact with a roadway as can be seen in FIGS. 5 and 6 which show a section along the line V-V made in FIG. 3. FIG. 5 shows the section when this portion is not in contact with a roadway while FIG. 6 shows the same section when coming into contact. FIG. 5 shows each section of the cavity portions 41 and 42 extended towards the running surface 11 by a sipe 5 of depthwise wavy shape. Between the cavity portions 41 and 42 a cavity portion 44 which provides the continuity of the cavity volume extends. FIG. 6 shows that the sipe 5—by virtue of its thickness-wise wavy geometry—closes close to the cavity 4 and over the whole length Lc of the cavity 4 under the effect of the forces of contact with the roadway and thus ensures a constant cavity volume Vc so as to allow said cavity to play its resonator role.

FIG. 4 shows in perspective a partial view of the tread shown with FIG. 3. This FIG. 4 shows a cavity 4 and more particularly the portion 40 of this cavity of reduced section opening onto a lateral face 210 of the rib 21; this cavity 4 is extended radially towards the running surface 11 by a sipe 5, the latter opening via a sipe portion 51 onto the lateral face 210. In this variant, the cavities 4 are formed at a depth that is appropriate for opening on the running surface before the legal wear limit indicated by at least one wear indicator (not shown here). In this variant, the cavity portions 41, 42, 44, when they open onto the running surface, play the role of grooves which are useful both for generating new ridges and for draining the water that may be present in the contact patch.

In the present case, the sum Ly of the lengths projected in the transverse direction (marked by the direction YY′ in FIG. 3) of the cavity is equal to 48 mm (twice the length L1 of the cavity portions 41, 42) while the sum Lx of the lengths projected in the circumferential direction (marked by the direction XX′ in FIG. 3) is equal to 28 mm (the length L2 of the portion 43). The ratio Ly/Lx is in this instance equal to 1.7.

In this way, it is possible to have 1.7 times more cavity length in the transverse direction than in the circumferential direction, which is favorable from a point of view of rigidity of the rib. Specifically, each cavity according to the invention leads to less of a change to the transverse rigidity of this element.

In this first example of a tire according to the invention, each resonator formed in a rib is entirely formed in the tread so as to be effective for attenuating the resonance noise at least for ⅔ of the period of usage of the tread (that is to say that this cavity does not appear on the running surface before this wearing of the ⅔ of the thickness starting from the new state).

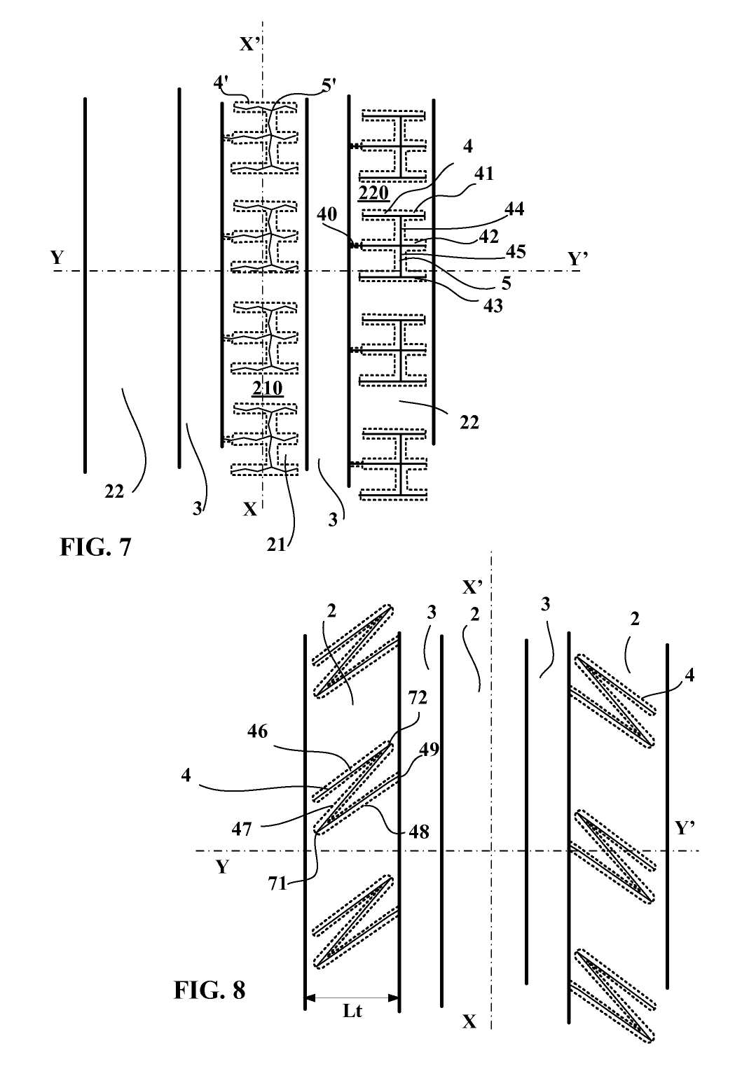

FIG. 7 shows, on one and the same tread, two variant embodiments of cavities according to which two ribs are provided with a plurality of cavities, each cavity forming a Helmholtz resonator with a total volume Vc. On one side rib 22 of the tread, each cavity 4 is formed of three cavity portions 41, 42, 43, each of length L1, oriented parallel to the transverse direction (the rotation axis of the tire marked by the direction YY′) and two cavity portions 44, 45 oriented in the circumferential direction in order to link together in twos the cavity portions oriented transversely. All these cavity portions 41, 42, 43, 44, 45 have substantially the same circular cylindrical shape (but this shape may be adapted to requirements). One of the cavity portions 42 oriented parallel to the transverse direction opens onto a lateral wall of the rib via a cavity portion of reduced section 40 in order to place the cavity 4 in communication with the rib 2 the resonance noise of which it is sought to reduce. Each cavity 4 is extended radially outwards by a sipe 5 of which the intersection with the running surface 220 in the new state reproduces the geometry of the cavity (three branches of sipes parallel to the transverse direction and two circumferential branches connecting the foregoing together). The function of these cavities 4 is to reduce the resonance noise of the groove 3 between the side rib 22 in which they are formed and the central rib 21.

Formed on the central rib is a plurality of cavities 4′ playing the role of Helmholtz resonators, these cavities 4′ have substantially the same geometry as the cavities 4 formed on one of the side ribs described above. The only visible difference from the foregoing cavities lies in the geometry of the sipe 5′ connecting each cavity 4′ to the contact face of the rib. Each sipe 5′ follows a zigzag trace on the contact face and on any surface inside the tread between the running surface and the cavity 4′; in this way, the interaction of the facing walls formed by said sipe is increased. Superposed on this zigzag trace of the sipe 5′ is a zigzag geometry in the direction of the thickness of the tread. It should also be understood by zigzag that it is possible to adopt any geometry promoting a mechanical blocking of the walls delimiting the sipe and situated facing one another. The function of these cavities 4 is to reduce the resonance noise of the groove 3 between the side rib 22 having no cavities and the central rib 21.

FIG. 8 represents another variant of the invention using resonators of the quarter-wave type on a tread comprising two circumferential grooves 3 delimited by ribs 2 of the same width. The axially outermost ribs are provided with a plurality of cavities 4 each having a shape quite close to that of the letter “Z”. In this variant, each cavity 4 has a total length Lc that is substantially greater than three times the length Lt of each rib and comprises three linear cavity portions 46, 47, 48 connected together by connection portions 71, 72, each cavity portion 46, 47, 48 being inclined relative to the transverse direction at an angle different from zero degrees. One end 49 of each cavity opens into the lateral wall of each rib so that the cavity 4 forms a quarter-wave resonator. It can be seen in this variant that a large percentage of the total length Lc of each cavity is oriented in the transverse direction (in a ratio greater than 1.5). In this variant, all the cavities 4 are oriented in the same manner on one and the same rib and, on the other rib, in an orientation that is symmetrical relative to the circumferential direction XX′. Clearly it would be possible to choose to have one and the same orientation for all the cavities irrespective of the rib. It is also possible to have, on one and the same intermediate rib, cavities for reducing the resonance noise in one groove and cavities for reducing the resonance noise in another groove, said grooves delimiting the intermediate rib. Moreover, each cavity is extended by a sipe capable of closing in the vicinity of said cavity.

The distance between the cavities, irrespective of the variant in question, is chosen so as to reconcile both the need to attenuate the resonance noise and the need to limit the reduction in rigidity.

Naturally, the invention that has just been described by means of several variants is not limited to these variants alone and various modifications can be made thereto without departing from the context defined by the claims. Notably, it is possible to combine, on one and the same tread, a plurality of cavities of the Helmholtz resonator type and cavities of the quarter-wave resonator type. It is also possible to use such noise-attenuating devices in the case of a groove delimited by a plurality of blocks. In another variant embodiment, each cavity may be extended not towards the running surface but towards the inside of the tread: this involves the tread being manufactured separately before it is incorporated into the tire.

1. A tire comprising a tread having a running surface designed to come into contact with a roadway when the tire is running, this tread comprising at least one groove of generally circumferential orientation and a plurality of relief elements, each of these relief elements comprising a contact face with a transverse width Lt, this contact face forming a portion of the running surface and of the lateral walls, certain of these lateral walls partly delimiting the grooves of generally circumferential orientation, at least one relief element being provided with a plurality of devices for attenuating resonance noise generated in a circumferential groove, each device being formed in a relief element and comprising a cavity of elongate shape having a total length Lc and a total volume Vc, this cavity being entirely formed in the tread, this cavity opening onto a lateral wall delimiting the circumferential groove the resonance noise of which it is sought to reduce, this cavity having a total length Lc which is greater than the transverse width Lt of the relief element, and a geometry comprising several cavity portions connected together, the length Lc being equal to the sum of the lengths of all the cavity portions, these cavity portions having a total length projected in the circumferential direction equal to Lx and a total length projected in the transverse direction equal to Ly, the projected total lengths Lx, Ly being equal respectively to the sum of the lengths of the projections in the circumferential direction or in the transverse direction of each cavity portion, each cavity being extended over the whole of its length Lc by a sipe extending radially outwards in order to open onto the running surface, wherein the sum Ly of the lengths projected in the transverse direction of each cavity is at least 1.5 times greater than the sum Lx of the lengths projected in the circumferential direction of each cavity.

2. The tire according to claim 1, wherein the total length Lc of each cavity of a relief element is at least equal to twice the transverse width Lt of the said relief element.

3. The tire according to claim 2, wherein the sipe has an average width of less than 0.6 mm.

4. The tire having a tread according to claim 3, wherein the sipe comprises a sipe portion originating on the cavity and forming an angle A of least 10 degrees with a perpendicular to the running surface and passing through the point of intersection of the sipe with the cavity, so that the sipe is closed at least close to the cavity in order to conserve the total volume Vc of said cavity when the said cavity comes into contact with the roadway.

5. The tire having a tread according to claim 1, wherein at least one cavity has a shape comprising at least two portions of generally transverse orientation and at least one portion connecting these portions of generally transverse orientation together.

6. The tire having a tread according to claim 1, wherein, since the tread is provided with a wear indicator in the bottom of at least one groove, this wear indicator having a height h measured relative to the bottom of the groove, each cavity comprises an upper generatrix situated at a distance from the running surface that is at least equal to the depth of the grooves minus the height h of the wear indicator.

7. The tire according to claim 1, wherein at least certain cavities form Helmholtz resonators.

8. The tire according to claim 1, wherein at least certain cavities are quarter-wave resonators.

9. The tire according to claim 1, wherein each cavity is formed in the thickness of the tread so as to be effective at least for ⅔ of the period of usage of the tread.

10. The tire having a tread according to claim 1, further comprising a wear indicator in the bottom of at least one groove, this wear indicator having a height h measured relative to the bottom of the groove, and wherein each cavity comprises an upper generatrix situated at a distance from the running surface that is at least equal to the depth of the grooves minus the height h of the wear indicator and wherein each cavity is formed in the thickness of the tread so as to be effective at least for ⅔ of the period of usage of the tread.
